(19) United States
(12) Patent Application Publication
(10) Pub. No.: US 2023/0219742 A1
(43) Pub. Date: Jul. 13, 2023

(54) KNIFE CASE

(71) Applicant: AOB Products Company, Columbia, MO (US)

(72) Inventors: Dennis W. Cauley, Jr., Fayette, MO (US); James Tayon, Moberly, MO (US); Timothy S. Kinney, Warrenton, MO (US); Matthew Kinamore, Columbia, MO (US); Curtis Smith, Columbia, MO (US); Mark Dalton, Columbia, MO (US); Chris Lang, Columbia, MO (US)

(73) Assignee: AOB Products Company, Columbia, MO (US)

(21) Appl. No.: 18/173,527

(22) Filed: Feb. 23, 2023

Related U.S. Application Data
(63) Continuation of application No. 17/444,993, filed on Aug. 12, 2021.

(51) Int. Cl. A47G 21/14

(52) U.S. Cl. CPC A47G 21/14; B26B 7/00

(57) ABSTRACT

A knife case and associated components and methods. The knife case includes a case body and a plurality of holders. For example, the case may be configured to hold a plurality of blade components configured to be interchangeably mounted on a handle. The knife may be an electric knife, and the case can include a battery dock for holding a spare battery.

### CROSS-REFERENCE TO RELATED APPLICATION

The present application is a continuation of U.S. patent application Ser. No. 17/444,993, filed Aug. 12, 2021, and claims priority to U.S. Provisional Application No. 63/064,582, filed Aug. 12, 2020, both of which are hereby incorporated by reference in their entireties.

### FIELD

The present disclosure generally relates to equipment storage and more particularly to storage for knives and components thereof.

### BACKGROUND

Various types of cases for hand tools are known. In general, such cases hold the tools and associated components (e.g., battery and charger) for storage and transport.

### SUMMARY

In one aspect, a knife case is for holding a knife including a handle and at least first and second blade components interchangeably mountable on the handle. The knife case comprises a case body including first and second housing portions. The knife case comprises a first holder supported by the case body configured to hold the first blade component. The knife case comprises a second holder supported by the case body configured to hold the second blade component. The knife case comprises a third holder supported by the case body configured to hold the handle.

Other objects and features of the present disclosure will be in part apparent and in part pointed out herein.

### BRIEF DESCRIPTION OF THE DRAWINGS

FIG. 1 is a perspective of a knife case of the present disclosure in a closed configuration;

FIG. 2 is a perspective of the knife case in an open configuration;

FIG. 3 is a perspective of an upper housing of the knife case including blades of the knife;

FIG. 4 is a fragmentary view of the upper housing;

FIG. 5 is a perspective of a retainer member of the knife case;

FIG. 6 is a perspective of a lower housing of the knife case including a handle of the knife and batteries and a charger for the knife;

FIG. 7 is a perspective of a battery of the knife and a battery dock of the knife case;

FIG. 8 is a perspective of another embodiment of a knife case in an open configuration;

FIG. 9 is an enlarged fragmentary view of an upper housing of the knife case of FIG. 8;

FIG. 10 is an enlarged fragmentary section of the upper housing and a handle of the knife stowed thereon;

FIG. 11 is a perspective of a knife handle dock of the knife case;

FIG. 12 is a perspective of an alternative embodiment of a blade dock of the present disclosure;

FIG. 13 is a bottom perspective of the blade dock of FIG. 12;

FIG. 14 is a perspective of a retainer member of the blade dock of FIG. 12; and

FIG. 15 is a fragmentary section of a knife case showing details of a connection of a handle to a body of the knife case.

Corresponding reference characters indicate corresponding parts throughout the drawings.

### DETAILED DESCRIPTION

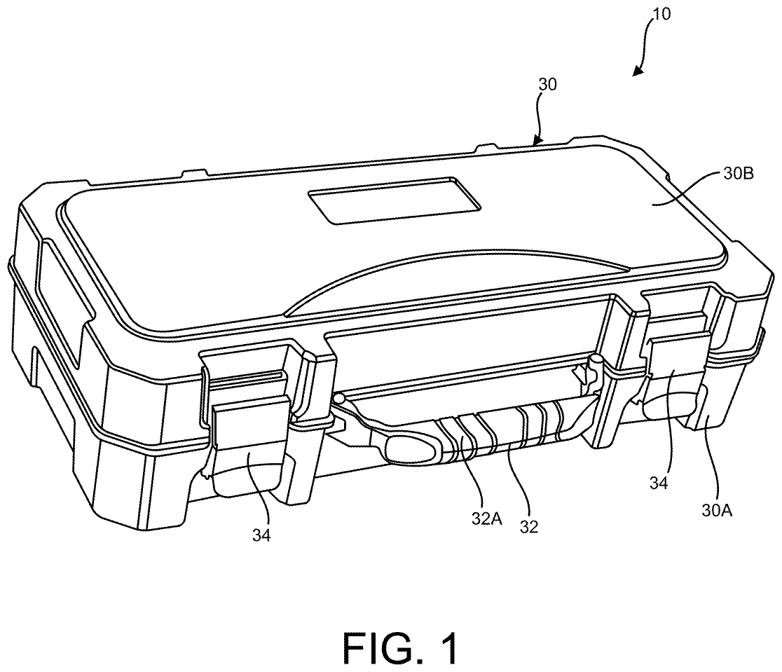

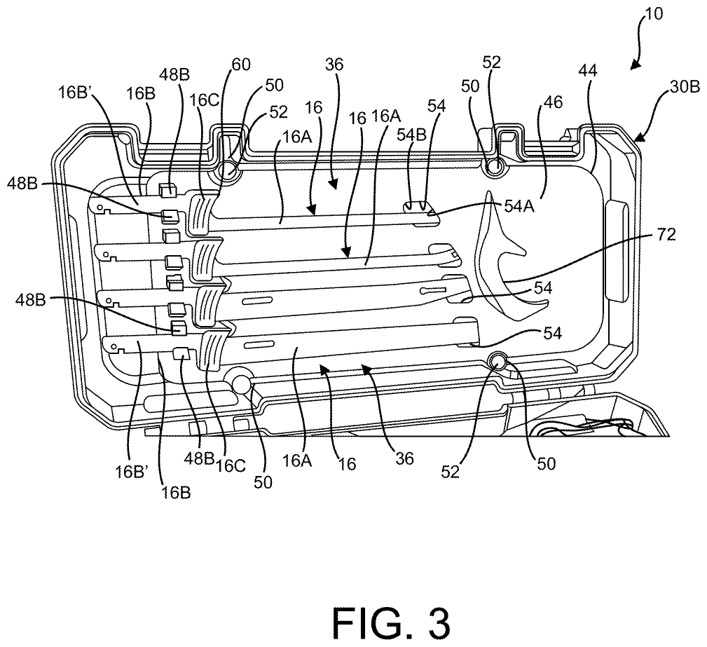

Referring to FIGS. 1-3, a first embodiment of a knife case (broadly, “tool case” or “equipment case”) of the present disclosure is indicated generally by 10. The knife case can be used for storing and transporting a knife and/or components thereof. In the illustrated embodiment, the knife case 10 is configured to store an electric knife 12 having interchangeable sets of blade components. It will be understood that knife cases according to the present invention could be configured for holding other types of knives or knife components without departing form the scope of the present disclosure. Moreover, it will be appreciated that aspects of the knife case could be incorporated in other types of cases, such as tool cases or equipment cases.

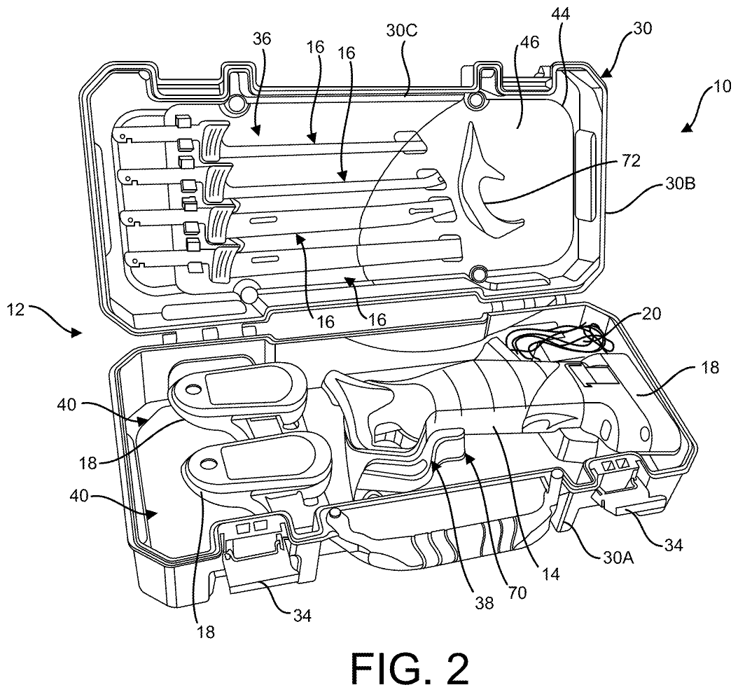

Referring to FIG. 2, the illustrated electric knife 12 includes a handle 14, a plurality of pairs of blade components 16, and a set of batteries 18. These can all be broadly referred to as “knife components.” One battery 18 is shown mounted on the handle 14, and two other batteries 18 are stowed in the case 10. A charger 20 is also stowed in the case 10. It will be appreciated that a user selects a pair of blade components 16 to be used with the handle 14, installs those blade components on the handle, and operates the knife to oscillate the blades with respect to each other for cutting. For example, the knife 12 may be used to fillet fish. The case 10 serves to store the components of the knife 12 together in a safe and organized manner.

Each blade component 16 includes a blade 16A (e.g., including a spine, opposing side faces, and a cutting edge). Each blade component 16 also has a tang 16B including a stem 16B′ receivable in the handle 14 for connecting the blade 16A to the handle. In the illustrated embodiment, the stem 16B′ and blade 16A are formed as a single piece of metal (broadly, a “blade component body”). Each blade component 16 further includes a grip 16C formed separately from the blade component body and connected to the tang 16B between the stem 16B′ and blade 16A such that the grip protrudes laterally from the blade component body. Each blade component 16 is a generally mirror image of the other blade component of the respective pair. The pairs of blade components 16 are stored (and used) with inboard faces of the blades 16A facing each other, outboard faces of the blades facing away from each other, and the grips 16C on opposite outboard sides of the blade components facing away from each other. The blade components 16 of a pair may include connection structure configured to connect the blades of the pair to each other but permit alternating oscillating movement of the blades with respect to each other.

Referring to FIG. 1, the case 10 includes a case body 30 and a handle 32. The case body 30 includes a lower (first) housing portion 30A and an upper (second) housing portion 30B. The housing portions are hinged to each other to permit movement of the upper housing portion 30B with respect to the lower housing portion 30A between an open position (e.g., FIG. 2), to arrange the case body 30 in an open configuration, and a closed position (e.g., FIG. 1), to arrange the case body in a closed configuration. In the closed configuration, an interior of the case body 30 is closed by the housing portions 30A, 30B. In the open configuration, the interior of the case body 30 is open for the user to view and access knife components stored therein. The upper housing portion 30B carries a gasket 30C for forming a seal between the upper and lower housing portions in the closed configuration.

The case 10 includes first and second releasable retainers 34 configured to releasably connect the upper housing portion 30B to the lower housing portion 30A to maintain the case body 30 in the closed configuration. In the illustrated embodiment, the retainers 34 comprise buckles or latches that can be selectively engaged with the upper housing portion 30B. The housing portions 30A, 30B can be formed of plastic (e.g., injection molded plastic) or another suitable material.

The case 10 includes a plurality of equipment holders for holding components of the knife 12. For example, the case 10 includes a plurality of blade component holders 36, a knife handle holder 38, and two battery holders 40. The blade component holders 36 and knife handle holder 38 can be broadly referred to as knife holders or knife component holders. The plurality of equipment holders 36, 38, 40 can also be referred to as tool or tool component holders or docks.

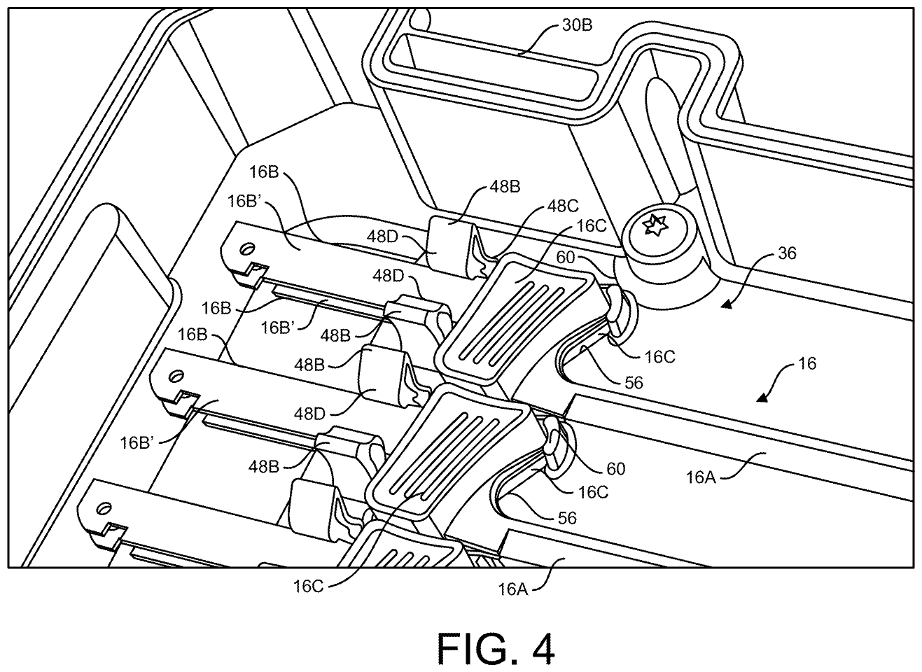

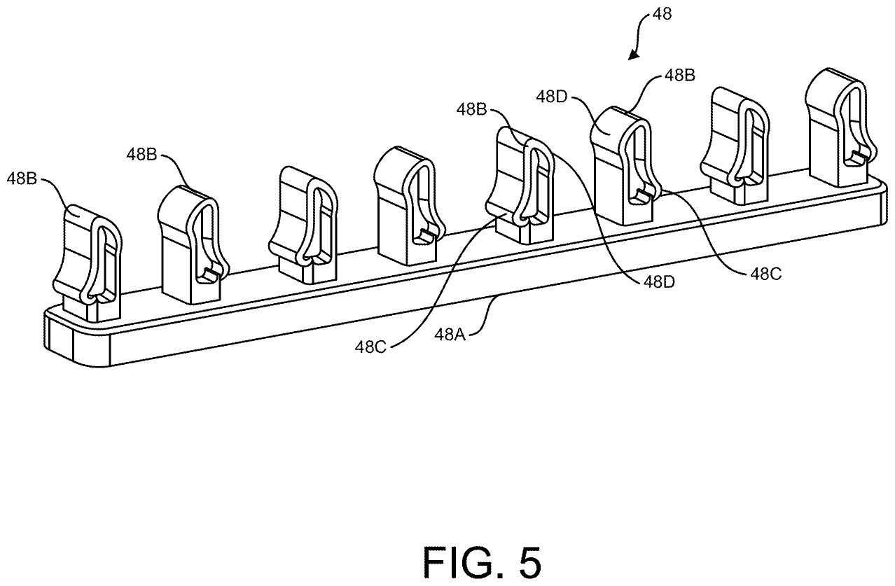

The case 10 includes a blade support insert 44 installed in the upper housing portion 30B. The blade support insert 44 forms the plurality of blade component holders 36. The blade support insert 44 comprises a blade support body 46 and a retainer member 48 (FIG. 5). Respective portions of the blade support body 46 and retainer member 48 form each blade component holder 36. The blade support body 46 can be formed of plastic (e.g., injection molded plastic) or another suitable material. The blade support body 46 includes a central web and several connectors 50 for receiving fasteners 52 (e.g., screws) for securing the blade support body 46 to the upper housing portion 30B. The blade support body 46 includes a plurality of blade receiving openings 54 in which distal end portions of the blades 16A are received and includes a plurality of stabilizing openings 56 (FIG. 4) in which grips 16C of the rear blade component 16 are received. The blade support body 46 and upper housing portion 30B form a pocket therebetween in which the tip of the blades 16A reside when received in the blade openings 54. The blade support body 46 includes ribs defining shoulders 60 (FIG. 4) located to abut distal ends of the grips 16C and/or the tang 16B to further locate the blade components in the respective holders 36.

As shown in FIG. 5, the retainer member 48 includes a main body 48A and a plurality of fingers 48B extending forward from the main body. The retainer member 48 can be formed of a resiliently compressible, elastomeric material, such as silicone or the like. Other materials such as injection molded plastic could be used. To install the retainer member 48 on the blade support body 46, the fingers 48B are moved through corresponding finger openings in the blade support body. The fingers 48B include barbs 48C that obstruct removal of the fingers from the finger openings to maintain the retainer member 48 on the blade support body 46. The fingers 48B temporarily deform to permit the barbs 48C to pass through the finger openings and then resiliently regain their shapes such that the barbs block removal of the fingers back out of the finger openings.

The arrangement is such that the fingers 48B of the retainer member 48 protrude forward from a front face of the blade support body 46. Pairs of the fingers form jaws 48B defining a knife component receiving space therebetween in which the blade components 16 (in particular the stems 16W) are receivable. Each finger 48B includes a keeper 48D that protrudes toward the other finger of the pair. The keeper 48D is arranged to overlie the knife component receiving space to obstruct withdrawal of the stem 163 from the knife component receiving space. The fingers 48B are resiliently deformable to permit the fingers to deflect away from each other to allow insertion of a pair of blade component stems 163 therebetween. When the blade component stems 163 are in the knife component receiving space, the fingers 48B desirably frictionally engage the stems to grip the stems and/or the keepers 48D overlie the stems to maintain the stems in position.

In view of the above, it will be appreciated that each blade component holder 36 includes a blade receiving opening 54, a stabilizing opening 56, a shoulder 60, and a pair of jaws 48B. The combination of these features holds a respective pair of blade components 16 in position in the case 10. To install a pair of blade components 16 in a respective blade component holder 36, the user may insert the tips of the blades 16A into the blade receiving opening 54, move the blade sufficiently into the blade receiving opening to move the stems 163 into registration with the jaws 48B, and pivot the pair of blade components to move the grip 16C of the rear blade component 16 into the stabilizing opening 56 and adjacent to the shoulder 60, until fully pushing the stems 163 of the blade components 16 between the jaws 48B behind the keepers 48D. Accordingly, the blade components 16 are held securely in the case 10 to resist movement in storage or during transport. Optionally, the blade component holder 36 may be configured to slightly flex the blade components 16 to help firmly hold the blade components in position. For example, the blade receiving opening 54 may have opposing edge segments 54A, 54B that engage the blade 16A and cause the blade to flex as the stems 16B′ are moved into the jaws 48B. This may assist in preventing the blades components 16 from rattling or moving out of position. The blade component holders 36 can also be referred to as knife component holders, and can have other configurations without departing from the scope of the present disclosure.

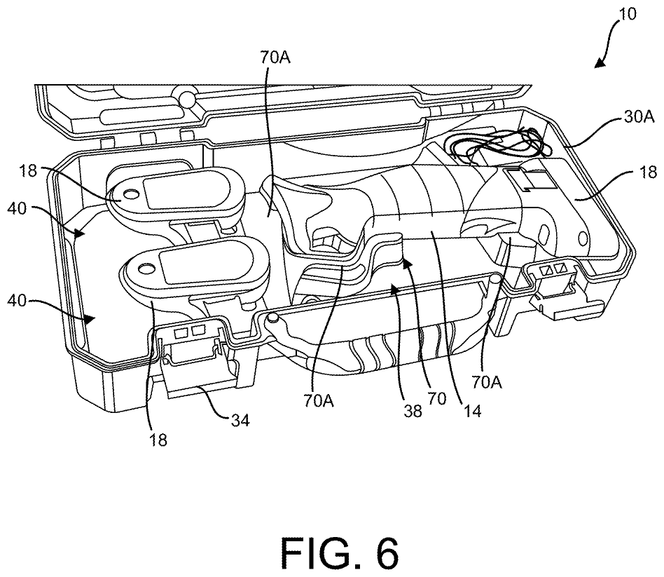

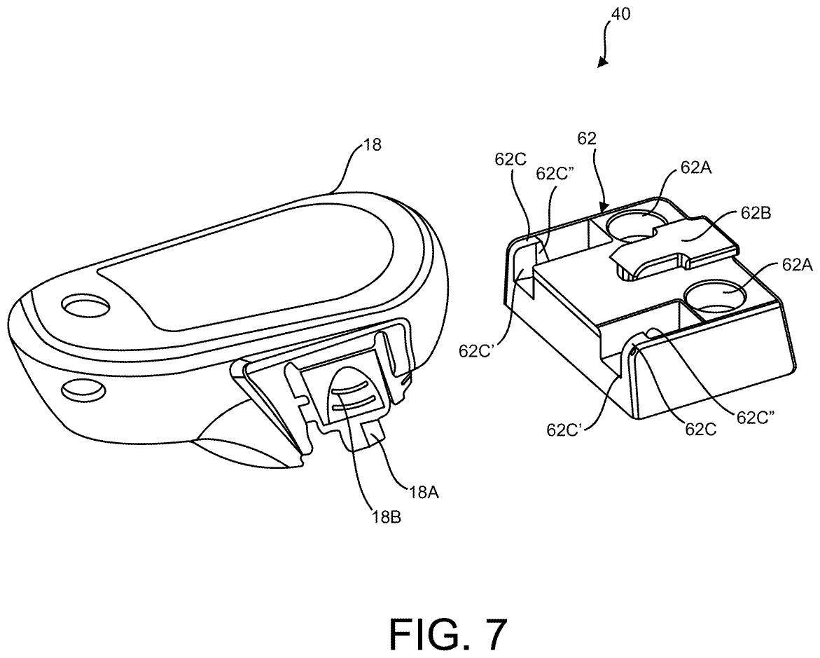

Referring to FIGS. 6 and 7, two battery holders 40 are provided for holding two batteries 18. Each battery holder 40 comprises a battery holder insert 62 defining a battery dock. The battery holder insert 62 can be formed of plastic (e.g., injection molded plastic) or any other suitable material. The battery holder insert 62 includes connectors 62A defining openings through which fasteners (e.g., screws) can be received for connecting the battery holder insert to the lower housing portion 30A. The battery dock comprises battery connection structure including a slide connector 62B and two retainers 62C. The slide connector 62B includes a T-shaped head sized and shaped to correspond to a T-shaped slot in the battery. Each retainer 62C includes a cam 62C′ and a keeper 62C″ arranged to engage spring-biased latches 18A of the battery. The arrangement is such that the battery 18 can be installed on the battery dock in the same way the battery is installed on the knife handle 14. More specifically, an open end of the T-shaped slot of the battery 18 is arranged in registration with the T-shaped head 62B, and the battery is moved onto the dock to receive the T-shaped head in the T-shaped slot. As the battery is moved, the spring-biased latches 18A of the battery engage and ride on the cams 62C′ inward until passing the keepers 62C″, when the latches resiliently extend to positions behind the keepers. The batteries 18 docked in such a fashion on the battery docks 62 holds the batteries in position in the case 10. To remove the battery 18, the user can press releases 18B of the battery to move the latches 18A out of retaining registration with the keepers 62C″ and then slide the battery off the T-shaped head 62B.

Referring to FIGS. 2 and 6, the handle holder 38 comprises a cradle 70 (broadly, “handle bed”) and a pusher 72 for keeping the handle 14 in position on the cradle. The cradle 70 is formed as part of the lower housing portion 30A and includes protrusions 70A contoured to define a handle receiving space closely corresponding to the size and shape of the handle. The pusher 72 is formed as a protrusion on the blade support body 46 and is located with respect to the cradle 70 to engage and push downward on the handle 14 when the case 10 is in the closed configuration. The latches 34 holding the upper housing portion 30B in the closed position maintain the pushing force of the pusher 72 on the handle 14. The arrangement is such that the handle 14 is maintained in position in the cradle 70 in storage and transport.

Referring to FIG. 1, the handle 32 is connected to the case body 30 to facilitate carrying the case. The handle 32 includes a handle body 32A having opposite end portions connected to the lower housing portion 30A. The handle body 32A can be formed of a flexible, resiliently compressible polymeric material to provide comfort to the user when grasping the handle. The connection of the end portions of the handle body 32A to the case body 30 will be described in further detail below.

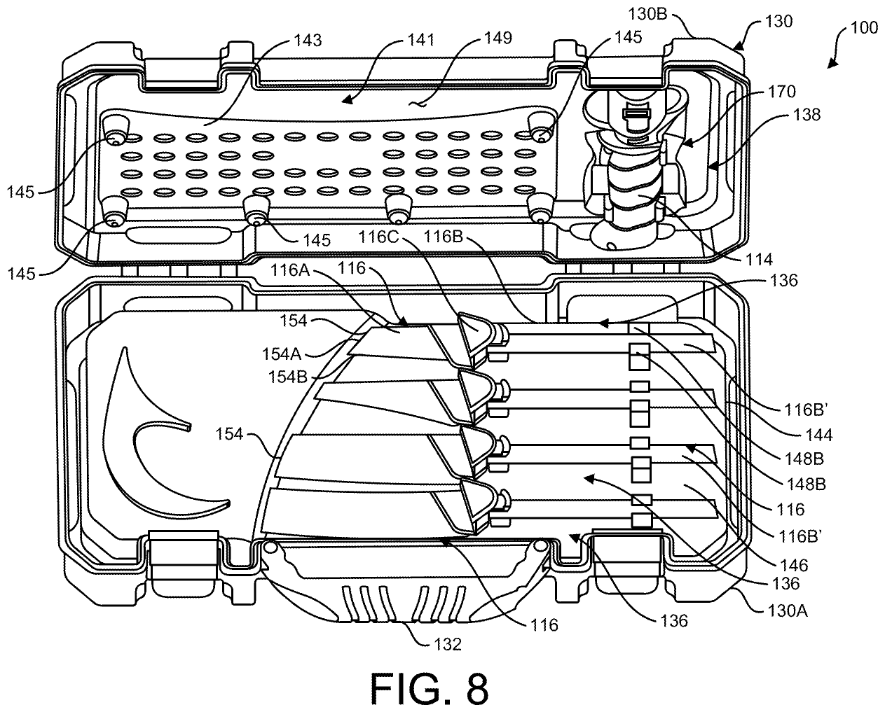

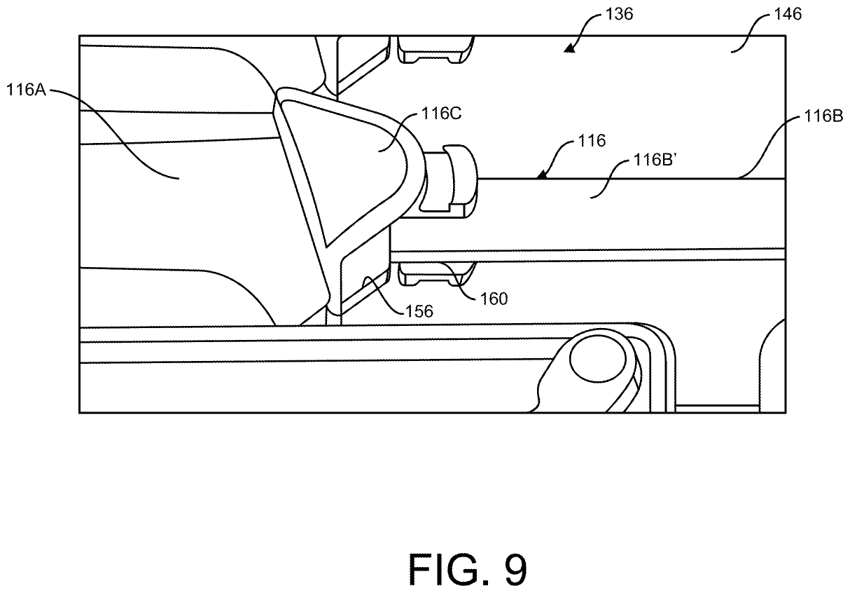

Referring to FIGS. 8-11, a second embodiment of a knife case of the present disclosure is generally indicated by 100. The knife case of this embodiment is similar to the knife case 10 of the prior embodiment, and like features are indicated by like reference numbers, plus 100. For example, the case 100 includes hinged lower and upper housing portions 130A, 130B and a handle 132. The case includes a blade support insert 144 defining a plurality of blade component holders 136. In this embodiment, the blade support insert 144 is installed on the lower housing portion 130A. The case 100 also includes a handle holder 138, which in this embodiment is on the upper housing portion 130B.

In this embodiment, the case 100 is configured for storing a non-electric interchangeable blade knife. The knife includes a handle 114 and a plurality of interchangeable blade components 116. Each blade component includes a blade 116A (e.g., including a spine, opposing side faces, and a cutting edge). Each blade component 116 also has a tang 116B including a stem 116B′ receivable in the handle 114 for connecting the blade to the handle. In the illustrated embodiment, the stem 116B′ and blade 116A are formed as a single piece of metal (broadly, a “blade component body”). Each blade component 116 further includes a grip 116C formed separately from the blade component body and connected to the tang 116B between the stem 116B′ and blade 116A. The grip 116C includes grip portions on opposite sides of the blade component body that protrude in opposing lateral directions from the blade component body. The grip 116C is also used to form a releasable connection between the blade component 116 and the handle 114 to connect the blade component to the handle. An example of such a knife is disclosed in greater detail in U.S. Patent Application Pub. No. 2020/0391397, which is hereby incorporated by reference in its entirety.

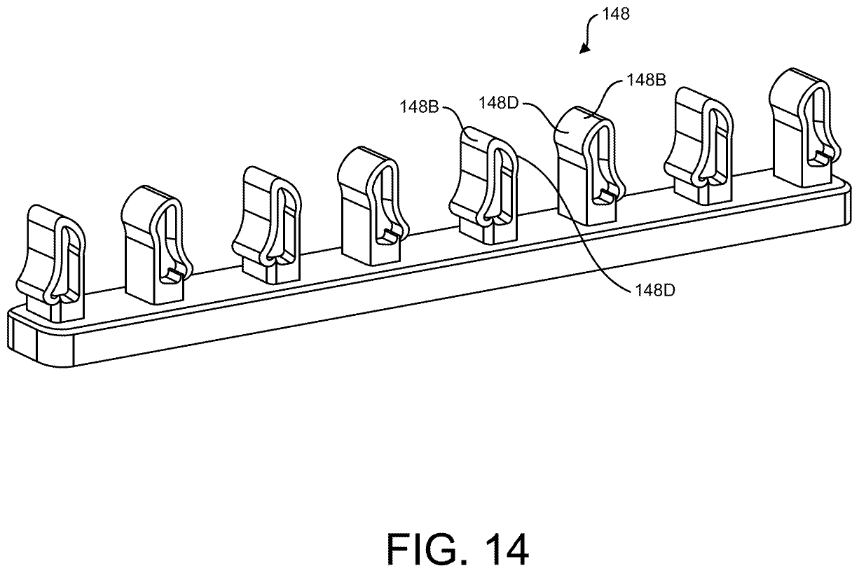

The blade support insert 144 forms the plurality of blade component holders 136. The blade support insert 144 comprises a blade support body 146 and a retainer member 148 (FIG. 14). Respective portions of the blade support body 146 and retainer member 148 form each blade component holder 136. The blade support body 146 can be formed of plastic (e.g., injection molded plastic) or another suitable material. The blade support body 146 includes a central web and can be connected to the lower housing portion by fasteners, adhesive, etc. The blade support body 146 includes a plurality of blade receiving openings 154 in which distal end portions of the blades 116A are received and includes a plurality of stabilizing openings 156 in which grips 116C of the blade components 116 are received. The blade support body 146 and lower housing portion 130A form a pocket therebetween in which the tip of the blades 116A reside when received in the blade openings. The blade support body 146 includes ribs defining shoulders 160 located to abut sides of the grips 116C to further locate the blade components in the respective holders.

As shown in FIG. 14, the retainer member 148 has the same construction as the retainer member 48 of FIG. 5. The retainer member 148 is installed on the blade support body 146 in the same way as described above. The arrangement is such that the fingers 148B of the retainer member 148 protrude forward from a front face of the blade support body 146. Pairs of the fingers form jaws 148B defining a knife component receiving space therebetween in which the blade components 116 (in particular the stems 1163) are receivable. Each finger 148B includes a keeper 148D that protrudes toward the other finger 148B of a respective pair. The keeper 148D is arranged to overlie the knife component receiving space to obstruct withdrawal of the stem 1163 from the knife component receiving space. The fingers 148B are resiliently deformable to permit the fingers to deflect away from each other to allow insertion of a blade component stem 116B′ therebetween. When the blade component stem 1163 is in the knife component receiving space, the fingers 148B desirably frictionally engage the stems to grip the stems and/or the keepers 148D overlie the stems to maintain the stems in position.

In view of the above, it will be appreciated that each blade component holder 136 includes a blade receiving opening 154, a stabilizing opening 156, a shoulder 160, and a pair of jaws 148B. The combination of these features holds a blade component 116 in position in the case 100. To install a blade component 116 in a respective blade component holder 136, the user may insert the tips of the blades 116A into the blade receiving opening 154, move the blade sufficiently into the blade receiving opening to move the stems 116B′ into registration with the jaws 148B, and pivot the blade component to move the grip 116C into the stabilizing opening 156 and adjacent to the shoulder 160, until fully pushing the stem of the blade component between the jaws 148B behind the keepers 148D. Accordingly, the blade component 116 is held securely in the case 100 to resist movement in storage or during transport. Optionally, the blade component holder 136 may be configured to slightly flex the blade component 116 to help firmly hold the blade component in position. For example, the blade receiving opening 154 may have opposing edge segments 154A, 154B that engage the blade 116A and cause the blade to flex as the stem 116B′ is moved into the jaws 148B. This may assist in preventing the blade components 116 from rattling or moving out of position. The blade component holders 136 can also be referred to as knife component holders, and can have other configurations without departing from the scope of the present disclosure.

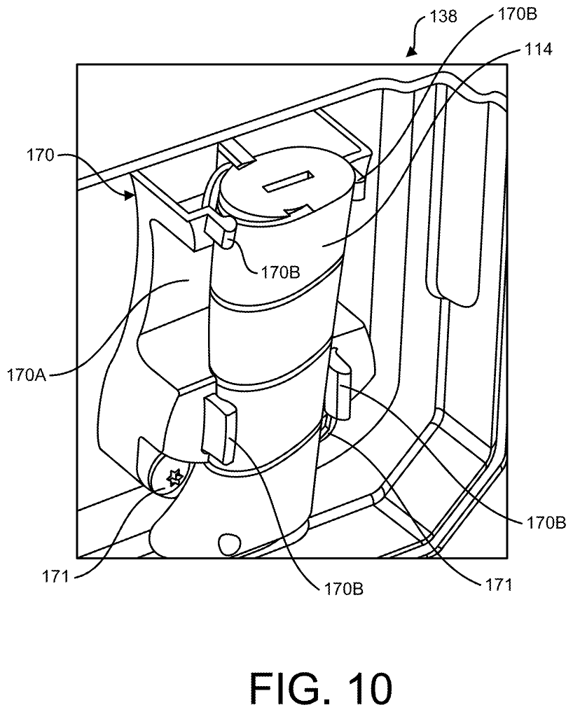

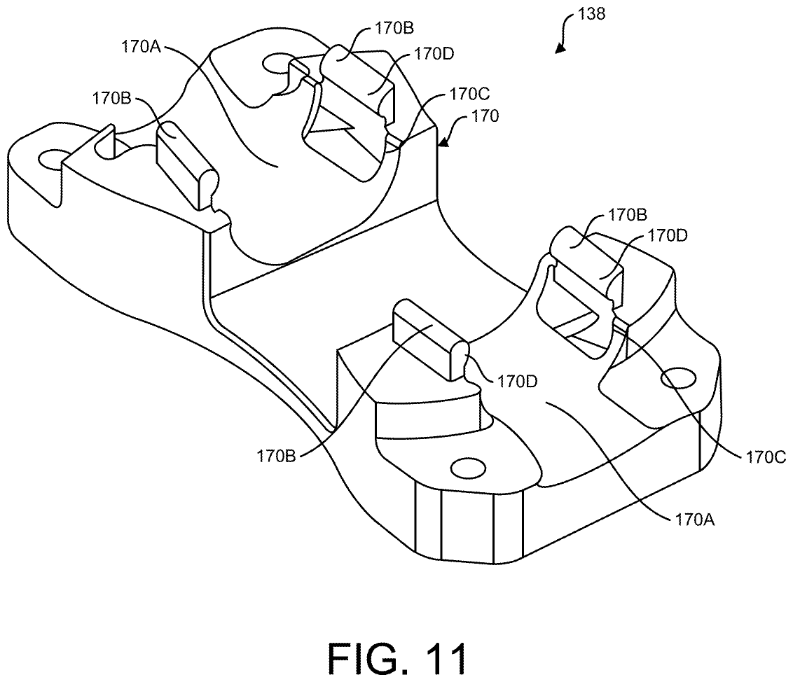

Referring to FIGS. 10 and 11, the handle holder 138 comprises a cradle 170 (broadly, “handle bed”) for keeping the handle 114 in position on the cradle. In this embodiment, the cradle 170 is formed separately from the case body 130 and is connected by fasteners 171 (e.g., screws) to the upper housing portion 130B. The cradle 170 includes a bed 170A on which the handle is receivable and a plurality of arms 170B configured to grip the handle to maintain the handle on the bed. The arms 170B are located with each other to form a friction fit or interference fit with the handle 114. The arms 170B include keepers 170D. The cradle 170 can be formed of plastic (e.g., injection molded plastic) or another suitable material. In the illustrated embodiment, relief recesses 170C are provided in the cradle 170 to promote flexibility of the arms 170B with respect to the bed 170A. The arrangement is such that the arms 170B are pivotable with respect to the bed 170A about living hinge connections to the bed to resiliently deflect outward as the handle is installed between the arms. The arms 170B thus firmly grip the handle 114 and maintain the handle in position.

The case 100 also includes an accessory holder 141 configured to permit the user to stow various accessories in the case. The accessory holder 141 includes a panel 143 of flexible, resiliently extendable webbing. For example, the panel 143 can be made of an elastomeric material such as silicone. The panel 143 includes a plurality of openings and is secured to the upper housing portion 130B by a plurality of fasteners 145 (e.g., screws). The panel 143 forms a pocket between the webbing and the upper housing portion 130B. The flexible, resiliently extendable nature of the webbing 143 permits accessories of various sizes and shapes (e.g., ring of keys) to be received in and securely held by the accessory holder 141. To install something in the accessory holder 141, the user pulls the webbing 143 away from the upper housing portion 130B to open a mouth 149 of the pocket. After placing the object(s) in the pocket, the user releases the webbing 143, which resiliently retracts and tends to regain its original shape, thus pressing the object(s) against the upper housing portion 130B, closing the mouth of the pocket, and maintain the object(s) in the pocket.

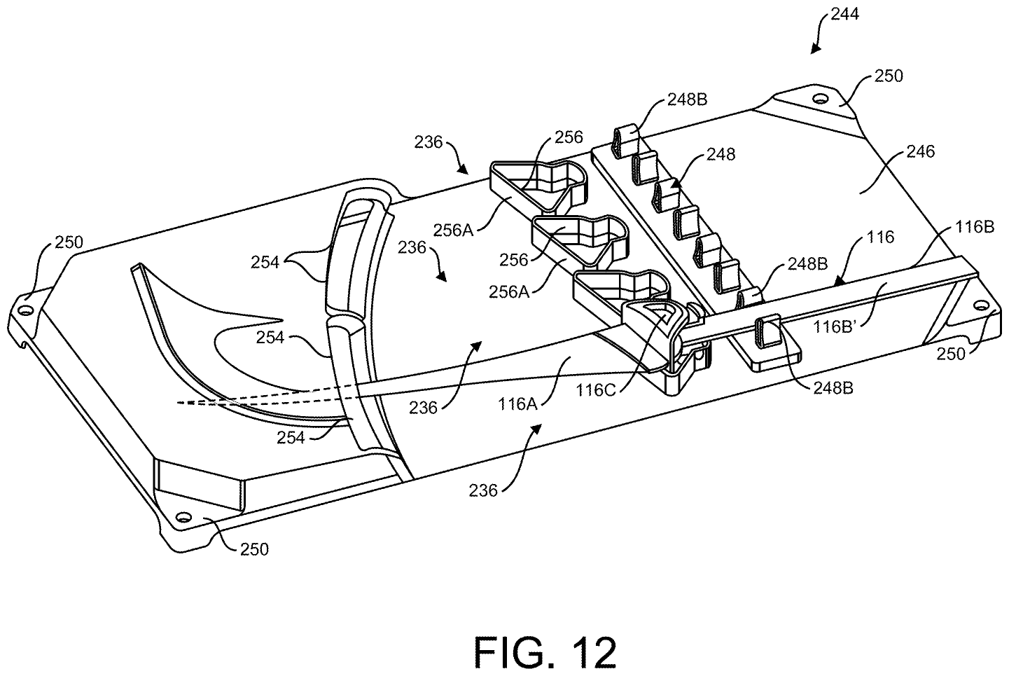

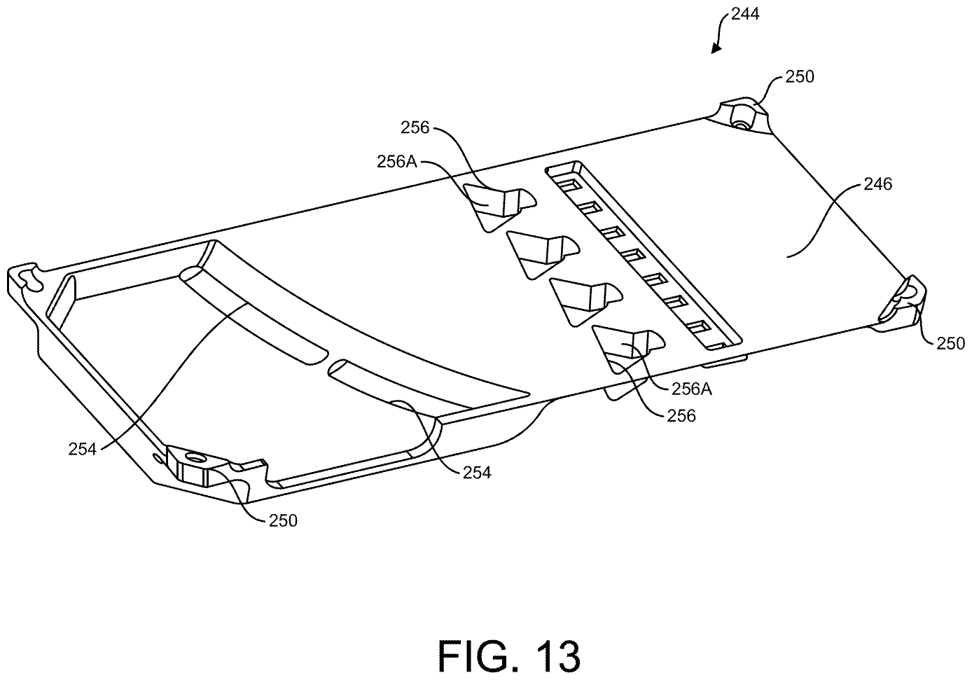

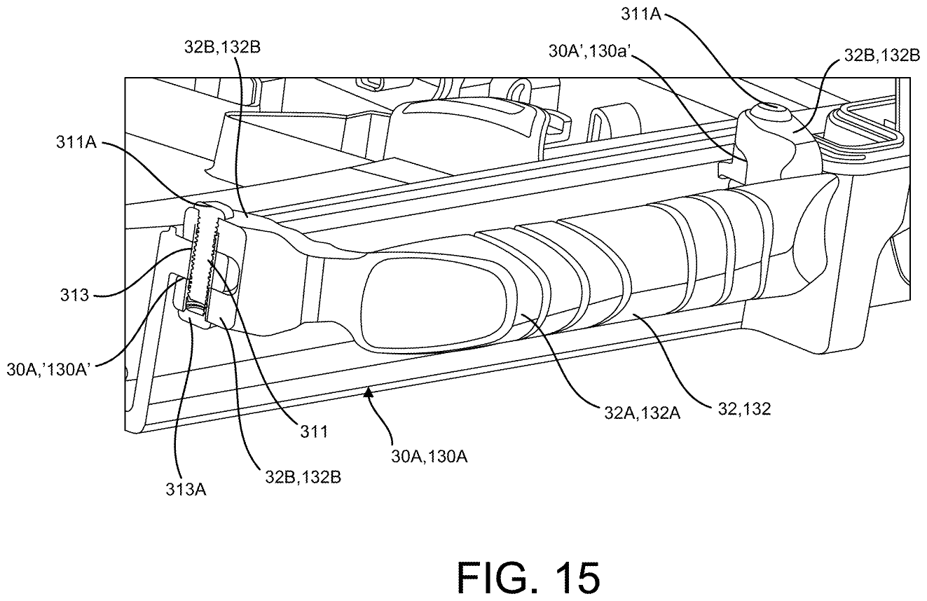

Referring to FIGS. 12 and 13, an alternative embodiment of a blade support insert 244 is shown. The blade support insert 244 is similar to the blade support insert 144 of FIG. 15, and like components are indicated by like reference numbers, plus 100. For example, the blade support insert 244 includes a blade support body 246 and retainer member 248 forming a plurality of blade component holders 236. The blade support body 246 can be formed of plastic (e.g., injection molded plastic) or another suitable material. The blade support body 246 includes a central web and connectors 250 defining openings for receiving fasteners (e.g., screws) for securing the blade support insert to the lower housing portion 130A. The blade support body 246 includes a plurality of blade receiving openings 254 in which distal end portions of the blades 116A are received and includes a plurality of stabilizing openings 256 in which grips 116C of the blade components 116 are received. In this embodiment, the stabilizing openings 256 are bounded by lips 256A protruding from the front face of the blade support body 246. The lips 256A extend around the stabilizing openings 256 and are configured to engage the grips 116C received therein. The stabilizing openings 256 are sized and shaped to correspond to the size and shape of a grip portion 116C to be received therein to maintain position of the blade component 116. The blade support body 246 and lower housing portion 130A form a pocket therebetween in which the tip of the blades 116A reside when received in the blade openings.

The retainer member 248 has the same construction as the retainer member 148 and is used with the blade support body 246 for forming this blade support insert 244. The jaws 248B operate in the same fashion as described above to maintain the blade components 116 in position. Accordingly, it will be appreciated that each blade component holder 236 includes a blade receiving opening 254, a stabilizing opening 256, and a pair of jaws 248B. The blade components 116 can be installed in the blade component holders 236 in a similar fashion as described above.

An example configuration for connecting the handle 32, 132 to the case bodies 30, 130 will be described in more detail with respect FIG. 15. The handle 32, 132 is connected to the case body 30, 130 to facilitate carrying the case 10, 100. The opposite end portions of the handle body include opposing eyelets 32B, 132B arranged to straddle an eyelet 30A′, 130A′ of the lower hosing portion 30A, 130A. The handle eyelets 32B, 132B are connected to the lower housing portion 30A, 130A by Chicago fasteners. The Chicago fasteners each include a screw 311 having a male thread and a barrel nut 313 having a female thread configured to mate with the male thread. The screw 311 and barrel nut 313 each have heads 311A, 313A configured to abut outer surfaces of the handle body 32A, 132A. The arrangement is such that, when the eyelets 30A′, 130A′ of the lower housing portion 30A, 130A are arranged between and in registration with the handle eyelets 32B, 132B, the screw 311 and barrel nut 313 can be installed from opposite directions in the openings and threaded together. Desirably, the screw 311 is threaded into the barrel nut 313 sufficiently such that the heads 311A, 331A of the screw and barrel nut engage and compress the material of the handle body 32A, 132A. The resiliently compressible material of the handle body 32A, 132A applies an outward bias to the heads 311A, 313A, thus applying a frictional force to the heads to prevent rotation and maintain the threaded connection.

It will be apparent that modifications and variations are possible without departing from the scope of the appended claims.

As various changes could be made in the above constructions and methods without departing from the scope of the disclosure, it is intended that all matter contained in the above description and shown in the accompanying drawings shall be interpreted as illustrative and not in a limiting sense.

1. (canceled)

2. A knife component storage container for holding a knife component including a blade having a longitudinal axis and a tip, the knife component having a distal portion toward the tip and having a proximal portion farther than the distal portion from the tip, the knife component storage container comprising:
a knife component support configured to support the knife component for storage of the knife component, the knife component support including:
a proximal holding portion configured to hold the proximal portion of the knife component; and
a distal holding portion configured to hold the distal portion of the knife component, the distal holding portion being arranged with respect to the proximal holding portion to apply a bending force to the blade when the knife component is held by the proximal holding portion and the distal holding portion.

3. The knife component storage container of claim 2, wherein the distal holding portion is configured to receive the distal portion of the knife component by longitudinal movement of the blade into the distal holding portion.

4. The knife component storage container of claim 3, wherein the proximal holding portion is configured to receive the proximal portion of the knife component by movement of the blade in a direction transverse to the longitudinal axis of the blade.

5. The knife component storage container of claim 2, wherein the proximal holding portion includes a first opening and a second opening, the first and second openings being spaced from each other and configured to receive the proximal portion of the knife component.

6. The knife component storage container of claim 5, wherein the proximal holding portion includes a pair of jaws, the jaws defining the first opening therebetween.

7. The knife component storage container of claim 2, wherein the proximal holding portion includes a pair of jaws, the jaws defining an opening therebetween for receiving the proximal portion of the knife component, at least one of the jaws being resiliently deformable to deform upon insertion of the proximal portion of the knife component in the opening and to apply a holding force to the proximal portion of the knife component.

8. The knife component storage container of claim 2, wherein the proximal holding portion includes an opening configured to receive a portion of the knife component when the knife component is held by the proximal holding portion.

9. The knife component storage container of claim 2, wherein the proximal holding portion includes a pair of resiliently deformable fingers between which the proximal portion of the knife component is receivable for holding the proximal portion of the knife component.

10. The knife component storage container of claim 5, wherein the knife component support includes a knife component support body and a retainer, the retainer being formed separately from the knife component support body and connected to the knife component support body, the retainer comprising a resiliently deformable finger protruding from the knife component support body and forming part of the proximal holding portion.

11. The knife component storage container of claim 2, wherein the knife component is a first knife component, the proximal holding portion is a first proximal holding portion, the distal holding portion is a first distal holding portion, and the knife component support is configured to support a second knife component including a blade, the knife component support including:
a second proximal holding portion configured to hold a proximal portion of the second knife component; and
a second distal holding portion configured to hold a distal portion of the second knife component, the second distal holding portion being arranged with respect to the second proximal holding portion to apply a bending force to the blade of the second knife component when the second knife component is held by the second proximal holding portion and the second distal holding portion.

12. The knife component storage container of claim 2, in combination with the knife component, the knife component including a tang and a grip.

13. A knife component storage container for holding a knife component, the knife component storage container comprising:
a knife component support configured to support the knife component for storage of the knife component, the knife component support including a holding portion configured to hold the knife component, the knife component support comprising:
a knife component support body, and
a resiliently deformable finger formed separately from the knife component support body and connected to the knife component support body, the resiliently deformable finger protruding from the knife component support body and forming part of the holding portion.

14. The knife component storage container of claim 13, further comprising a second resiliently deformable finger forming a part of the holding portion, the first and second resiliently deformable fingers defining a gap therebetween for receiving the knife component.

15. The knife component storage container of claim 14, wherein the first and second resiliently deformable fingers are integrally formed as a retainer formed separately from the knife component support body and connected to the knife component support body.

16. The knife component storage container of claim 15, wherein the knife component support body has a first side and an opposite second side, the second side of the knife component support body defining a retainer body receiver configured to receivably hold a retainer body of the retainer such that the first and second resiliently deformable fingers extend through the knife component support body from the second side of the knife component support body to the first side of the knife component support body.

17. The knife component storage container of claim 13, wherein the holding portion is a first holding portion, the resiliently deformable finger is a first resiliently deformable finger, and the knife component support includes a second holding portion for holding a second knife component, the second holding portion comprising a second resiliently deformable finger formed separately from the knife component support body and connected to the knife component support body, the second resiliently deformable finger protruding from the knife component support body.

18. The knife component storage container of claim 17, wherein the knife component support body has a first side and an opposite second side, the second side of the knife component support body defining a retainer body receiver configured to receivably hold a retainer body of the retainer such that the first and second resiliently deformable fingers extend through the knife component support body from the second side of the knife component support body to the first side of the knife component support body.

19. The knife component storage container of claim 18, further comprising a housing defining an interior in which the knife component support is located, the housing including a first housing portion and a second housing portion movable with respect to the first housing portion for opening and closing the interior.

20. The knife component storage container of claim 13, in combination with the knife component, the knife component including a tang and a grip.

21. A knife component storage container for holding a knife component, the knife component including at least one of a blade, a handle, or a battery, the knife component storage container comprising:
a container body;
a knife component support body formed separately from the container body and connected to the container body, the knife component support body formed by injection molding and defining a holding portion configured to hold the knife component.

22. The knife component storage container of claim 21, wherein the holding portion is configured to hold the handle of the knife.

23. The knife component storage container of claim 21, wherein the holding portion is configured to hold the blade of the knife.

24. The knife component storage container of claim 21, wherein the holding portion is configured to hold the battery of the knife.

25. The knife component storage container of claim 21, wherein the container body defines an interior and includes a first housing portion and a second housing portion connected to the first housing portion, the second housing portion being movable with respect to the first housing portion to open and close the interior.

26. The knife component storage container of claim 21, in combination with the knife component, the knife component including the handle and the blade.
